(19) United States
(12) Patent Application Publication
(10) Pub. No.: US 2016/0261735 A1
(43) Pub. Date: Sep. 8, 2016

(54) METHOD AND SYSTEM TO DISABLE RECORDING

(71) Applicant: SONY CORPORATION, Tokyo (JP)

(72) Inventor: BRANT CANDELORE, SAN DIEGO, CA (US)

(21) Appl. No.: 14/640,223

(22) Filed: Mar. 6, 2015

(51) Int. Cl. H04M 1/725; H04N 5/232; H04W 4/00

(52) U.S. Cl. CPC H04M 1/72577; H04W 4/008; H04M 1/72572; H04N 5/23209

(57) ABSTRACT

Various aspects of a method and system to disable recording are disclosed herein. The method is executed within a recording device. The recording device detects a signal generated by an electronic device when the recording device is within a pre-defined proximity range of the electronic device. In response to the detected signal, the recording is disabled.

### FIELD

Various embodiments of the disclosure relate to disabling data recording. More specifically, various embodiments of the disclosure relate to disabling recording of data based on a signal in a radio frequency (RF) spectrum and/or a visual cue.

### BACKGROUND

Advancements in the field of content capturing technologies have led to miniaturized optical components with advanced content capturing functionalities. Such miniaturized optical components may be readily integrated into portable electronic devices, such as smartphones. Such integration may enable users to capture high-resolution images of a desired object and/or environment.

In certain scenarios, several objects and/or environments may be restricted and thus, may prohibit image and/or video content to be recorded. Examples of such restricted objects may be registered posters, literary works, historical scriptures, ancient statues, and/or the like. Examples of such restricted environments may be a museum, a theater, an art gallery, a public space, and/or the like. In such scenarios, the content owners may want to prohibit content recording of such restricted objects and/or environments for various reasons. Existing technologies may not provide desirable provisions to the content owners to protect their own content from being captured by unauthorized content capturing devices.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A method and a system to disable recording are provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a network environment, in accordance with an embodiment of the disclosure.

FIG. 2 is a block diagram that illustrates various components of a recording device, in accordance with an embodiment of the disclosure.

FIG. 3 is a block diagram that illustrates various components of an electronic device, in accordance with an embodiment of the disclosure.

FIG. 4 illustrates a first exemplary scenario to implement the disclosed method and system to disable recording, in accordance with an embodiment of the disclosure.

FIG. 5 illustrates a second exemplary scenario to implement the disclosed method and system to disable recording, in accordance with an embodiment of the disclosure.

FIG. 6 is a flow chart that illustrates a method to disable recording, in accordance with an embodiment of the disclosure.

### DETAILED DESCRIPTION

Various implementations may be found in a method and/or a system to disable data recording. The method may be executed within a recording device. The recording device may detect a signal generated by an electronic device when the recording device is within a pre-defined proximity range of the electronic device. In response to the detected signal, the recording device may disable the recording of the data.

In accordance with an embodiment, the data recording may be disabled when an identifier associated with the recording device does not match an identifier list. The identifier list may correspond to one or more authorized recording devices. The identifier list may be embedded within the detected signal. In accordance with an embodiment, the detected signal may comprise an embedded watermark. In such a case, the data recording may be disabled based on the embedded watermark.

In accordance with an embodiment, the signal may be transmitted by the electronic device via one of a radio frequency (RF) spectrum, a wireless fidelity (Wi-Fi) network, and a Bluetooth network. In accordance with an embodiment, the signal may be immune to be superimposed by a white noise signal. In accordance with an embodiment, the signal may be immune to be superimposed by another signal. The other signal may be previously copied from one or more electronic circuitries from within the recording device, previously transmitted by the recording device, and/or previously recorded within the recording device.

In accordance with an embodiment, the recording device may be disabled when a white noise signal is detected. In accordance with an embodiment, strength of the detected signal may be compared with a pre-defined threshold value. In accordance with an embodiment, the data recording may be disabled when the strength of the detected signal exceeds the pre-defined threshold value.

Another exemplary aspect of the disclosure may comprise a method to disable data recording. In accordance with an embodiment, the method may be executed within an electronic device. A signal may be generated when a recording device is within a pre-defined proximity range of the electronic device. The generated signal may be transmitted to the recording device. Based on the transmitted signal, data recording may be disabled in the recording device. In accordance with an embodiment, a watermark and an identifier list may be embedded within the transmitted signal. The identifier list may correspond to one or more authorized recording devices. In accordance with another embodiment, an identifier associated with the recording device may be compared with a pre-stored identifier list prior to the transmission. The pre-stored identifier list may correspond to one or more authorized recording devices. The recording device may be authorized to record the data based on the comparison.

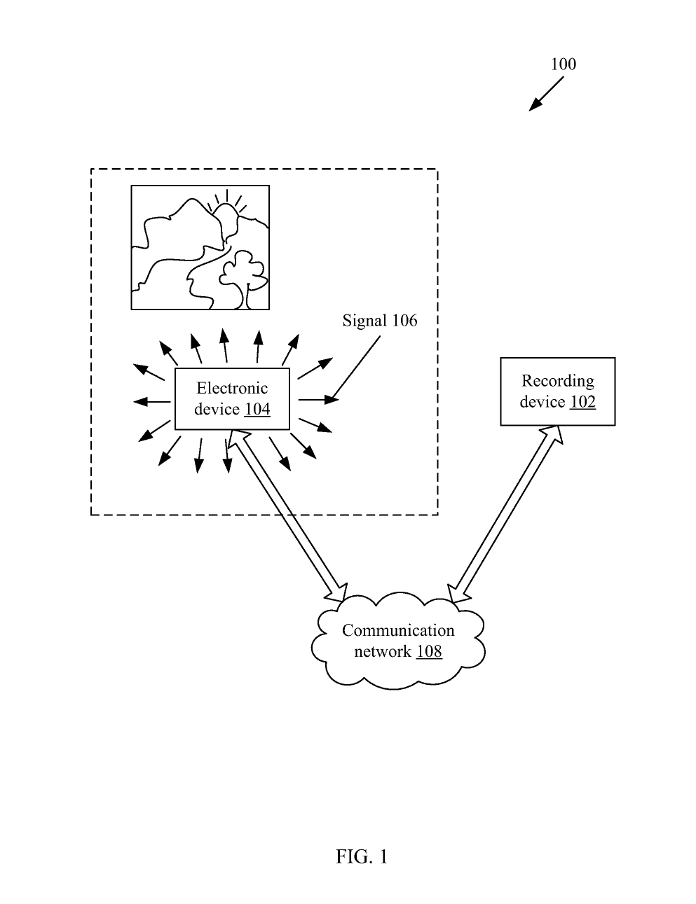

FIG. 1 is a block diagram that illustrates a network environment, in accordance with an embodiment of the disclosure. With reference to FIG. 1, there is shown a network environment 100. The network environment 100 may include a recording device 102, an electronic device 104, a signal 106, and a communication network 108. The recording device 102 may be communicatively coupled to the electronic device 104, via the communication network 108.

The recording device 102 may comprise suitable logic, circuitry, interfaces, optical components, and/or code that may be operable to capture data that may be a view of a real-world entity and/or a real-world environment. The view may be captured as a photograph or a video of the real-world entity or the environment. The recording device 102 may be further operable to record the captured data in a local memory. The recording device 102 may be further operable to disable the data recording when the signal 106 is detected by the recording device 102. The recording device 102 may be further operable to transmit location information to the electronic device 104. Examples of the recording device 102 may include, but are not limited to, a video recorder, a camcorder, a smartphone, a tablet, a phablet, and/or a laptop.

The electronic device 104 may comprise suitable logic, circuitry, interfaces, and/or code that may be operable to generate and transmit a signal 106. The signal 106 may be generated and transmitted based on a pre-specified condition. The pre-specified condition may include detection of the recording device 102 within a pre-defined proximity range of the electronic device 104. The pre-specified condition may further include an instance when the identifier of the recording device 102 is not found in a pre-stored identifier list of authorized recording devices. Based on the signal 106, the recording device 102 may be disabled such that the captured data is not recorded. The electronic device 104 may be operable to embed a watermark within the signal 106. In accordance with an embodiment, the embedded watermark may be visible to the human eye. In accordance with another embodiment, the embedded watermark may not be visible to the human eye. The electronic device 104, such as a radio frequency (RF) transmitter, may be embedded in another electronic device, such as a smartphone, a tablet, a phablet, and/or a laptop. The electronic device 104 may be operable to transmit the signal 106, in accordance with various RF signal modulation techniques, such as an amplitude-shift keying (ASK) mechanism, frequency-shift keying (FSK) mechanism, direct-sequence spread spectrum, frequency-hopping spread spectrum, and/or the like.

The signal 106 may be a function that may exhibit a variation in time or a variation in space in a radio frequency (RF) spectrum. The signal 106 may be generated and transmitted by the electronic device 104, based on the pre-specified condition. In accordance with an embodiment, signal 106 may be transmitted in a unidirectional or omnidirectional manner. In accordance with an embodiment, the signal 106 may be immune to be superimposed by a white noise signal. In accordance with an embodiment, the signal 106 may be immune to be superimposed by another signal. The other signal may be a previously copied signal from one or more electronic circuitries from within the recording device 102, previously transmitted signal by the recording device 102, and/or previously recorded signal within the recording device 102.

The communication network 108 may include a medium through which the recording device 102 and the electronic device 104 communicate with each other. Such a communication may be performed, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols. The communication network 108 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

In operation, a real-world entity may be located in a real-world environment that may be restricted for data recording. Examples of the real-world entity may include, but are not limited to, an object, a display screen, and/or a live event. The object may correspond to a registered poster, literary work, a historical scripture, and/or an ancient statue. The display screen may correspond to hardware component of the electronic device 104 that may render an animated image, a still image, a video clip, an illustration, and/or a presentation. The live event may be a play in a theater hall or a live sports event. In accordance with an embodiment, the real-world environment may be restricted by a visual cue displayed in the vicinity of the real-world entity. An example of the visual cue may be an indicator, “No Photo”, displayed near an ancient statue. The visual cue may also be displayed in a field-of-view (FOV) of the recording device 102 that captures the real-world entity. The real-world environment may be restricted by the signal 106 generated by the electronic device 104.

In accordance with an embodiment, when the real-world entity is the display screen, the media may be received from another electronic device (not shown) and/or one or more servers. In such a case, the received media may be rendered on the display panel of the recording device 102. Examples of the other electronic device may include a laptop, a smartphone, a tablet, and/or the like. Examples of the one or more servers may include a social networking server, a live streaming server, an application server, and/or the like.

In accordance with an embodiment, the electronic device 104 may detect the recording device 102, when the recording device 102 is within a pre-defined proximity range of the electronic device 104. In response to the detection, the electronic device 104 may generate the signal 106 and transmit the generated signal 106. In accordance with an embodiment, the electronic device 104 may continuously generate the signal 106 and transmit the signal 106.

In accordance with an embodiment, the strength of the signal 106 may be less than a pre-defined threshold value. In such a case, the signal 106 may not be detected by the recording device 102. In accordance with an embodiment, the strength of the signal 106 may exceed the pre-defined threshold value. In such a case, the signal 106 may be detected by the recording device 102.

In accordance with an embodiment, an identifier list may be embedded within the signal 106. The identifier list may include a list of identifiers associated with one or more authorized recording devices. In accordance with an embodiment, the recording device 102 may detect the signal 106 with the embedded identifier list. The recording device 102 may compare the identifier of the recording device 102 with each of the identifiers in the identifier list. In accordance with an embodiment, the identifier of the recording device 102 may match an identifier within the identifier list. In such a case, the recording device 102 may be authorized to record the data in the restricted environment. In accordance with an embodiment, the identifier of the recording device 102 may not match the one or more identifiers in the identifier list. In such a case, the recording device 102 may not be authorized to record the data in the restricted environment. In such a case, the recording functionality of the recording device 102 may be disabled. Accordingly, the recording device 102 may not be operable to capture and record the data in the local memory. In accordance with an embodiment, a notification may be displayed on a display panel of the recording device 102 for the user. Simultaneously, another notification may be displayed on a display panel of the recording device 102 for data owner.

In accordance with another implementation of the disclosure, the electronic device 104 may detect the recording device 102, when the recording device 102 is within the pre-defined proximity range of the electronic device 104. In response to the detection of the recording device 102, the electronic device 104 may receive an identifier associated with the recording device 102. The electronic device 104 may further receive the location information of the recording device 102. The electronic device 104 may perform a comparison of the received identifier with the pre-stored identifier list. In accordance with an embodiment, the received identifier may match an identifier from a pre-stored identifier list. In such a case, the recording device 102 may be authorized by the electronic device 104 to record the data. Such a recording device 102 may capture and record the data in the restricted environment. In accordance with an embodiment, the received identifier may not match with the pre-stored identifier list. In such a case, the signal 106 may be generated by the electronic device 104. The signal 106 may be sent to the recording device 102, based on the received identifier and the location information. Based on the signal 106, the recording functionality of the recording device 102 may be disabled. In accordance with an embodiment, the recording device 102 may display a notification on a display panel of the recording device 102 for the user. The notification may comprise an alert message, such as, “Recording disabled!”. In accordance with another embodiment, another notification may be displayed at the electronic device 104 for the data owner. The other notification may comprise another alert message, such as, “Unauthorized recording device(s) detected within the premises”. The notification may comprise the location information of the recording device 102 whose recording functionality is disabled.

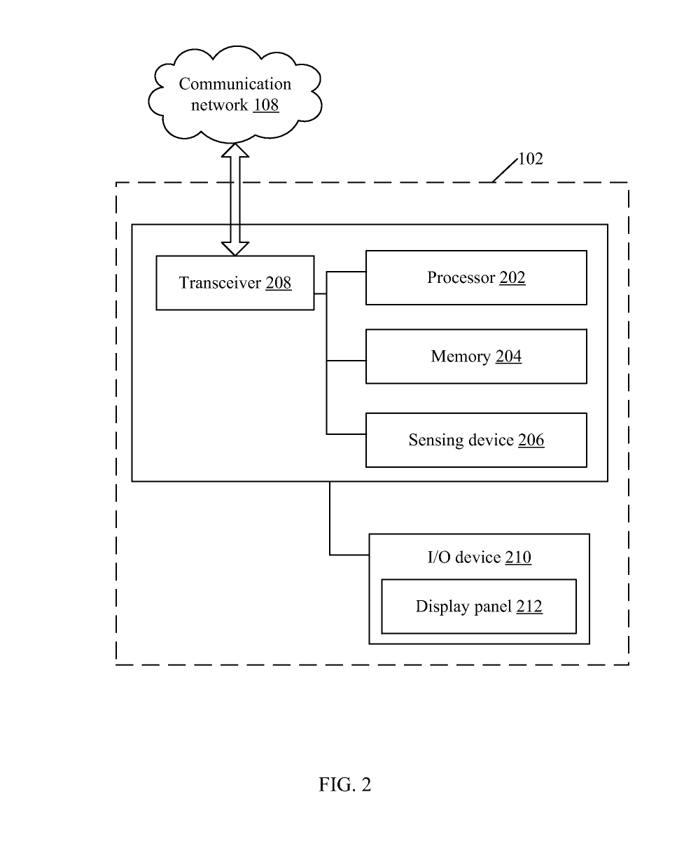

FIG. 2 is a block diagram that illustrates various components of a recording device, in accordance with an embodiment of the disclosure. FIG. 2 is explained in conjunction with elements from FIG. 1. With reference to FIG. 2, there is shown the recording device 102. The recording device 102 may comprise one or more processors, such as a processor 202, a memory 204, a sensing device 206, a transceiver 208, and an input/output (I/O) device 210. The I/O device 210 may further comprise a display panel 212. The processor 202 may be communicatively connected to the memory 204, the sensing device 206, the transceiver 208, and the I/O device 210. The transceiver 208 may be communicatively coupled to the communication network 108.

The processor 202 may comprise suitable logic, circuitry, interfaces, and/or code that may be operable to execute a set of instructions stored in the memory 204. The processor 202 may be further operable to compare the strength of the signal 106 with a pre-defined threshold value. The processor 202 may be further operable to compare the identifier of the recording device 102 with one or more identifiers within the identifier list. The processor 202 may be further operable to disable the data recording based on the comparison. The processor 202 may be implemented based on a number of processor technologies known in the art. Examples of the processor 202 may be an X86-based processor, a Reduced Instruction Set Computing (RISC) processor, an Application-Specific Integrated Circuit (ASIC) processor, a Complex Instruction Set Computing (CISC) processor, and/or other processor.

The memory 204 may comprise suitable logic, circuitry, interfaces, and/or code that may be operable to store the set of instructions, which may be executed by the processor 202. In accordance with an embodiment, the memory 204 may be operable to store one or more optical character recognition (OCR) algorithms. The memory 204 may be implemented based on a Random Access Memory (RAM), a Read-Only Memory (ROM), a Hard Disk Drive (HDD), a storage server, and/or a Secure Digital (SD) card.

The sensing device 206 may comprise suitable logic, circuitry, and/or interfaces that may be operable to include one or more sensors configured to detect the signal 106. The sensing device 206 may include one or more image sensors configured to capture a field-of-view (FOV) that includes a real-world entity. Examples of such one or more image sensors may include, but are not limited to, a complementary metal-oxide semiconductor (CMOS) sensor and/or a charge-coupled device (CCD) sensor. The sensing device 206 may further include one or more global positioning system (GPS) sensors configured to detect location information of the recording device 102. In accordance with an embodiment, the sensing device 206 may be operable to recognize one or more characters in the FOV, based on the one or more OCR algorithms retrieved from the memory 204.

The transceiver 208 may comprise suitable logic, circuitry, interfaces, and/or code that may be operable to receive the signal 106, generated by the electronic device 104. The transceiver 208 may be further operable to transmit an identifier to the electronic device104, via the communication network 108. The transceiver 208 may implement known technologies to support wired or wireless communication with the communication network 108. The transceiver 208 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 208 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The I/O device 210 may comprise suitable logic, circuitry, interfaces, and/or code that may be operable to receive an input from a user (not shown), or provide an output to the user. The I/O device 210 may comprise various input and output devices that may be operable to communicate with the processor 202. Examples of the I/O device 210 may include, but are not limited to, a keyboard, a mouse, a touch screen, a touch pad, a microphone, a camera, a motion sensor, a light sensor, and/or a docking station. The I/O unit may further include the display panel 212. Examples of the display panel 212 may include, but are not limited to, Liquid Crystal Display (LCD) display, Light Emitting Diode (LED) display, and/or an Organic LED (OLED) display technology.

In operation, a user (not shown) associated with the recording device 102 may desire to capture and record a FOV related to the real-world entity. In accordance with an embodiment, the electronic device 104 may detect the recording device 102, when the recording device 102 is within a pre-defined proximity range of the electronic device 104. In response to the detection, the electronic device 104 may generate and transmit the signal 106. In accordance with an embodiment, the signal 106 may be in a radio frequency (RF) spectrum detectable by the sensing device 206.

In accordance with an embodiment, the transceiver 208 may receive the signal 106 embedded with a watermark and an identifier list. The watermark may indicate that photography of the FOV related to the real-world entity is prohibited. The identifier list may include a list of identifiers associated with one or more authorized recording devices. The identifier may be a device identifier such as a media access control address (MAC address), an internet protocol (IP) address, and/or the like. The processor 202, in conjunction with the sensing device 206, may detect the identifier list and the watermark embedded within the signal 106. The processor 202 may compare the identifier of the recording device 102 with one or more identifiers within the identifier list. The processor 202 may further compare the watermark in the signal 106 with a pre-stored list of watermarks retrieved from the memory 204. In accordance with an embodiment, the watermark in the received signal 106 may match one of the plurality of watermarks and the detected identifier list in the received signal 106 may not match the identifier of the recording device 102. In such a case, the processor 202 may disable the recording functionality of the recording device 102. Accordingly, the recording device 102 may not be operable to capture and record the data in the memory 204. In accordance with an embodiment, the processor 202 may display a notification on a display panel 212 of the recording device 102 for the user.

In accordance with another embodiment, another recording device (not shown) with another identifier may desire to capture and record the data. The processor (not shown) of the other recording device, in conjunction with associated sensing device (not shown), may detect both the watermark and the identifier list from the received signal 106. In such a case, the watermark in the received signal 106 may match one of the plurality of watermarks. Further, an identifier from the detected identifier list may match the identifier of the other recording device. In such a case, the processor in the other recording device may be allowed to record the data in the restricted environment.

In accordance with another implementation of the disclosure, the electronic device 104 may detect the recording device 102, when the recording device 102 is within a pre-defined proximity range of the electronic device 104. In response to the detection, the transceiver 208 may transmit an identifier to the electronic device 104, via the communication network 108. The identifier may correspond to an identity of the recording device 102. The electronic device 104 may perform authorization based on the pre-stored identifier list stored within the local memory of the electronic device 104. The electronic device 104 may perform a comparison of the received identifier with the pre-stored identifier list. In accordance with an embodiment, the received identifier matches with a pre-stored identifier list. In such a case, the recording device 102 may be authorized by the electronic device 104 to record the data. The recording device 102 may capture and record the data in the restricted environment based on the authorization. In accordance with an embodiment, the received identifier may not match the pre-stored identifier list. In such a case, the recording device 102 may not be authorized by the electronic device 104 to record the data. In such a case, the signal 106 may be generated and transmitted by the electronic device 104. In accordance with an embodiment, the signal 106 may be in a radio frequency (RF) spectrum detectable by the sensing device 206.

The sensing device 206 may be operable to detect the signal 106 received from the electronic device 104. In response to the detection of the signal 106, the processor 202 may determine whether the strength of the signal 106 exceeds the pre-defined threshold value. When the strength of the signal exceeds the threshold value, then the signal 106 may disable the data recording at the recording device 102. When the strength of the signal is below the threshold value, then the signal 106 may be ignored. In accordance with an embodiment, the recording device 102 may detect the embedded watermark in the signal 106. Based on the watermark, the functional ability of the recording device 102 to record the data may be disabled.

Accordingly, the recording device 102 may not be operable to capture and record the data in the memory 204. The recording device 102 may be non-operative when the white noise signals and/or other signals (such as previously recorded signal within the recording device 102) are present. In accordance with an embodiment, a notification may be displayed on the display panel 212 of the recording device 102 for the user.

In accordance with an embodiment, the user associated with the recording device 102 may desire to capture and record a real-world entity located in a real-world environment that may be restricted by a visual cue. The visual cue may comprise a graphical indicator, “No Photo”, displayed in the vicinity of the real-world entity. The visual cue may further comprise the identifier list of one or more authorized recording devices. Examples of the visual cue may further include a graphical symbol, a set of characters, and/or an annotation that may indicate prohibition to capture the data. The visual cue may also be displayed in the FOV of the recording device 102 that captures the real-world entity.

In such a case, the processor 202, in conjunction with the sensing device 206, may be operable to detect the visual cue based on one or more OCR algorithms retrieved from the memory 204. In accordance with an embodiment, the processor 202, in conjunction with the sensing device 206, may be operable to detect the graphical indicator and the identifier list based on one or more OCR algorithms retrieved from the memory 204. The processor 202 may be operable to compare the detected graphical indicator with a pre-stored list of graphical indicators within the memory 204. The processor 202 may further compare the identifier of the recording device 102 with each of the detected identifier list in the visual cue. In accordance with an embodiment, a match for the detected graphical indicator is found within the pre-stored list of graphical indicators. Further, the identifier of the recording device 102 may not match with the detected identifier list. In such a case, the processor 202 may disable the functional ability of the recording device 102 to record the data. A notification that corresponds to the disabled functional ability of the recording device 102 may be displayed at the display panel 212 for the user. In accordance with an embodiment, when a match for the identifier of the recording device 102 is not found within the detected identifier list, the processor 202 may not disable the functional ability of the recording device 102 to record the data.

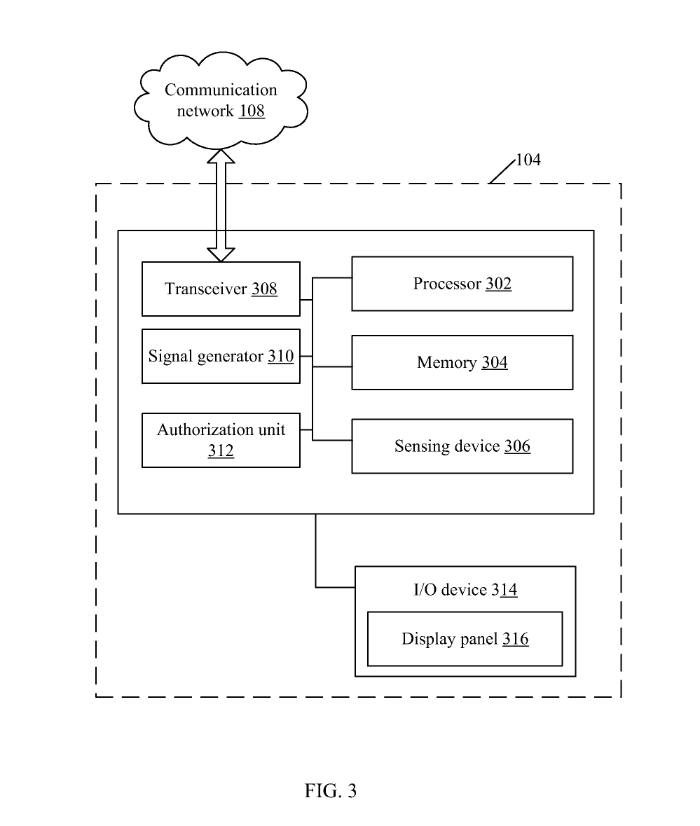

FIG. 3 is a block diagram that illustrates various components of an electronic device 104, in accordance with an embodiment of the disclosure. FIG. 3 is explained in conjunction with elements from FIG. 1 and FIG. 2. With reference to FIG. 3, there is shown the electronic device 104. The electronic device 104 may comprise one or more processors, such as a processor 302, a memory 304, a sensing device 306, a transceiver 308, a signal generator 310, an authorization unit 312, and an input/output (I/O) device 314. The I/O device 314 may further comprise a display panel 316. The processor 302 may be communicatively connected to the memory 304, the sensing device 306, the transceiver 308, the authorization unit 312, and the I/O device 314. The transceiver 308 may be communicatively coupled to the communication network 108.

The processor 302 may comprise suitable logic, circuitry, interfaces, and/or code that may be operable to execute a set of instructions stored in the memory 304. The processor 302 may be implemented based on a number of processor technologies known in the art. Examples of the processor 302 may be an X86-based processor, a Reduced Instruction Set Computing (RISC) processor, an Application-Specific Integrated Circuit (ASIC) processor, a Complex Instruction Set Computing (CISC) processor, and/or other processor.

The memory 304 may comprise suitable logic, circuitry, interfaces, and/or code that may be operable to store the set of instructions, which may be executed by the processor 302. The memory 304 may be operable to store one or more authorization algorithms that are well known in the art. The memory 304 may be implemented based on a Random Access Memory (RAM), a Read-Only Memory (ROM), a Hard Disk Drive (HDD), a storage server, and/or a Secure Digital (SD) card.

The sensing device 306 may comprise suitable logic, circuitry, and/or interfaces that may be operable to include one or more sensors, such as a proximity sensor, a motion sensor and/or a global positioning system (GPS) sensor. The one or more sensors may be configured to detect one or more objects, such as the recording device 102, within the vicinity of the electronic device 104.

The transceiver 308 may comprise suitable logic, circuitry, interfaces, and/or code that may be operable to transmit the signal 106 generated by the signal generator 310. In accordance with an embodiment, the transceiver 308 may be operable to receive an identifier associated with the recording device 102 from the recording device 102, via the communication network 108. The transceiver 308 may be further operable to transmit a pre-stored identifier list of authorized recording devices to one or more recording devices. The transceiver 308 may implement known technologies to support wired or wireless communication with the communication network 108. The transceiver 308 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 308 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The signal generator 310 may comprise suitable logic, circuitry, and/or interfaces that may be operable to generate a signal 106 when the recording device 102 may be within a pre-defined proximity range of the electronic device 104. The signal 106 may be operable to disable data recording in the recording device 102. The signal generator 310 may generate the signal 106 with strength greater than a pre-defined threshold value. The signal generator 310 may generate a signal 106 such that an identifier list may be embedded within the signal 106. The signal generator 310 may generate a signal 106 such that a watermark may be embedded within the signal 106. In accordance with an embodiment, the embedded watermark may be visible to the human eye. In accordance with another embodiment, the embedded watermark may not be visible to human eye. In such a case, the embedded watermark may be detectable by one or more sensors of the sensing device 206. In accordance with an embodiment, the signal generator 310 may generate the signal 106 such that the signal 106 may be immune to superimposition by the white noise signal. In accordance with an embodiment, the signal generator 310 may generate the signal 106 such that the signal 106 signal may be immune to superimposition by another signal. The another signal may be a previously copied signal from one or more electronic circuitries from within the recording device 102, previously transmitted signal by the recording device 102, and/or previously recorded signal within the recording device 102.

The authorization unit 312 may comprise suitable logic, circuitry, and/or interfaces that may be operable to authenticate the recording device 102 for recording of data. In accordance with an embodiment, the authorization unit 312 may receive an identifier related to the recording device 102. In accordance with an embodiment, the identifier may be a device identifier of the recording device 102.

The I/O device 314 may comprise suitable logic, circuitry, interfaces, and/or code that may be operable to receive an input from a data owner (not shown), or provide an output to the data owner. The I/O device 314 may comprise various input and output devices that may be operable to communicate with the processor 302. Examples of the I/O device 314 may include, but are not limited to, a keyboard, a mouse, a touch screen, a touch pad, a microphone, a camera, a motion sensor, a light sensor, and/or a docking station. The I/O device 314 may further include the display panel 316. Examples of the display panel 316 may include, but are not limited to, Liquid Crystal Display (LCD) display, Light Emitting Diode (LED) display, and/or an Organic LED (OLED) display technology.

In operation, the sensing device 306 may be operable to detect the recording device 102 when the recording device 102 is within a pre-defined proximity range of the electronic device 104. In accordance with an embodiment, the recording device 102 may be detected based on one or more sensors of the sensing device 306. In response to the detection, the signal generator 310 may generate the signal 106. The signal 106 may have strength greater than a pre-defined threshold value. The signal generator 310 may embed a watermark and the identifier list within the signal 106.

The transceiver 308 may transmit the signal 106 embedded with the watermark and the identifier list. In accordance with an embodiment, the signal 106 may be in a radio frequency (RF) spectrum detectable by the sensing device 206. In accordance with an embodiment, the signal 106 may be a Wi-Fi signal and/or a Bluetooth signal. In accordance with an embodiment, the signal 106 may be received by the transceiver 208 of the recording device 102.

In accordance with an embodiment, the watermark and the identifier list may be detected by the recording device 102. The processor 202 may compare the identifier of the recording device 102 with one or more identifiers within the identifier list. The processor 202 may further compare the watermark in the signal 106 with a pre-stored list of watermarks retrieved from the memory 204. In accordance with an embodiment, the watermark in the received signal 106 may match with one of the plurality of watermarks. In accordance with another embodiment, the detected identifier list in the received signal 106 may not match with the identifier of the recording device 102. In such an embodiment, the processor 202 may disable the recording functionality of the recording device 102. Accordingly, the recording device 102 may not be operable to capture and record the data in the memory 204. In accordance with an embodiment, the processor 202 may display a notification on a display panel 316 of the recording device 102 for the data owner.

In accordance with another implementation of the disclosure, the sensing device 306 may be operable to detect the recording device 102 when the recording device 102 is within a pre-defined proximity range of the electronic device 104. In accordance with an embodiment, based on one or more sensors in the sensing device 306, the presence of the recording device 102 may be detected. In response to the detection, the processor 302 may send a request to the recording device 102 to transmit the identifier and/or location information associated with the recording device 102, via the communication network 108. Based on the request, the transceiver 308 may receive the identifier and/or location information, via the communication network 108.

In response to the reception of the identifier, the processor 302, in conjunction with the authorization unit 312, may compare the received identifier with the pre-stored identifier list of authorized recording devices retrieved from the memory 304. In accordance with an embodiment, a match may be found between the received identifier and the pre-stored identifier list of authorized recording devices. In such an embodiment, the recording device 102 may be allowed to record the data. In accordance with an embodiment, a match may not be found within the pre-stored identifier list of authorized recording devices. In such a case, the signal generator 310 may generate the signal 106. The signal 106 may have strength greater than a pre-defined threshold value. In accordance with an embodiment, a watermark may be embedded within the signal 106. The signal 106 may be operable to disable the recording functionality of the recording device 102. A notification that corresponds to the disabled functional ability of the recording device 102 may be displayed at the display panel 316 for the data owner. Based on the notification and other such notifications for the disabled functional ability of other such recording devices, the processor 302 may be operable to determine a statistical analysis of all such recording devices with disabled functional ability to record the data.

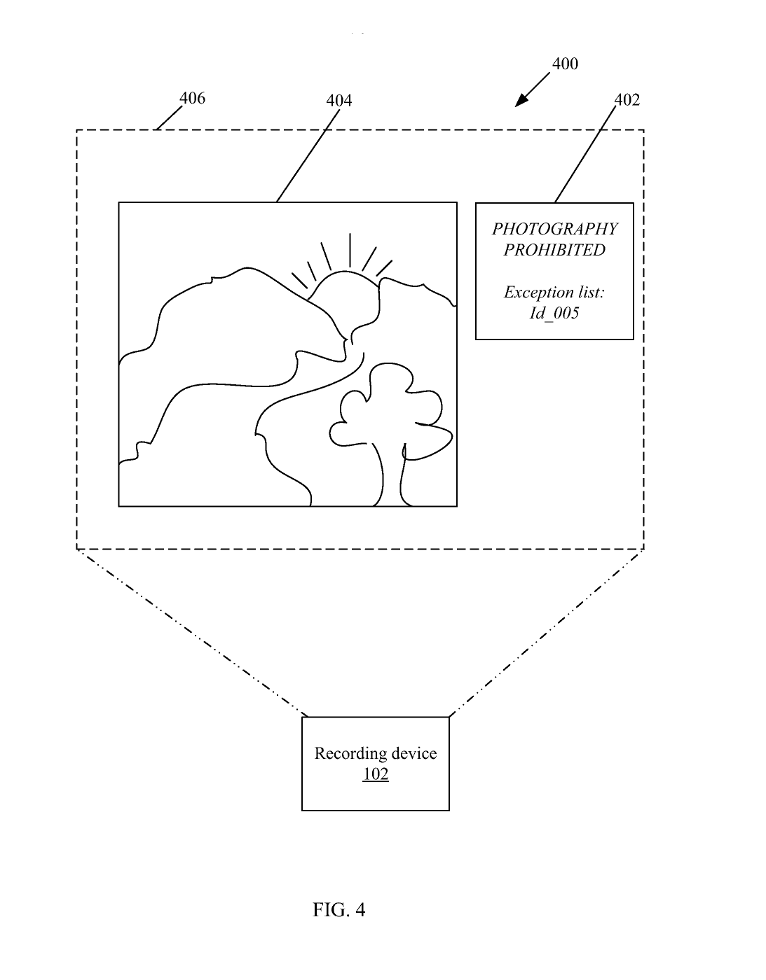

FIG. 4 illustrates a first exemplary scenario 400 to implement the disclosed method and system to disable data recording, in accordance with an embodiment of the disclosure. FIG. 4 is explained in conjunction with elements from FIG. 1 and FIG. 2. With reference to FIG. 4, there is shown a visual cue 402, data 404, a field-of-view (FOV) 406, and the recording device 102. The FOV 406 may comprise the data 404 and the visual cue 402. The FOV 406 may be captured by the recording device 102.

With reference to FIG. 4, the data 404 may correspond to a painting displayed in an art exhibition. The visual cue 402 may comprise an indicator, “PHOTOGRAPHY PROHIBITED”, so that recording devices may not be operable to capture the data 404. The visual cue 402 may further comprise an identifier list, such as, “Exception list: 1. Id_005”, to indicate that only the recording device with identifier, “Id_005”, is allowed to capture the data 404. The visual cue 402 may be displayed in vicinity of the data 404. The FOV 406, captured by the recording device 102, may comprise both the data 404 and the visual cue 402. Thus, the FOV 406 may be regarded as a restricted environment.

In accordance with an embodiment, when the recording device 102 may be within a pre-defined proximity range of the data 404, the sensing device 206 may detect the visual cue 402. The recording device 102 may be associated with an identifier, such as a device identifier, “Id_101”. The sensing device 206 may detect the visual cue 402 based on one or more image processing techniques. Examples of such image processing techniques may include one or more OCR algorithms retrieved from the memory 204 (as shown in FIG. 2). Based on the one or more OCR algorithms, the processor 202, in conjunction with the sensing device 206, may recognize both the indicator, “PHOTOGRAPHY PROHIBITED”, and the identifier list, “Exception list: 1. Id_005”, from the visual cue 402.

The processor 202 may compare the recognized indicator in the visual cue 402 with a pre-stored list of visual cues retrieved from the memory 204. The pre-stored list of visual cues may comprise a plurality of indicators. The processor 202 may further compare the recognized identifier list in the visual cue 402 with an identifier, such as the device identifier, “Id_101”, retrieved from the memory 204. In accordance with an embodiment, the recognized indicator in the visual cue 402 may match with one of the plurality of indicators and the recognized identifier list in the visual cue 402 may not match with the device identifier, “Id_101”. In such a case, the processor 202 may be disabled to record the data 404. In accordance with another embodiment, another recording device (not shown) with a device identifier, “Id_101”, may desire to capture and record the data 404. Based on the one or more OCR algorithms, a processor (not shown) of the other recording device, in conjunction with associated sensing device (not shown), may recognize both the indicator, “PHOTOGRAPHY PROHIBITED”, and the identifier list, “Exception list: 1. Id_005”, from the visual cue 402. In such a case, the recognized indicator in the visual cue 402 may match one of the plurality of indicators. Further, the recognized identifier list in the visual cue 402 may also match the device identifier, “Id_005” of the other recording device. In such a case, the processor in the other recording device may be allowed to record the data 404.

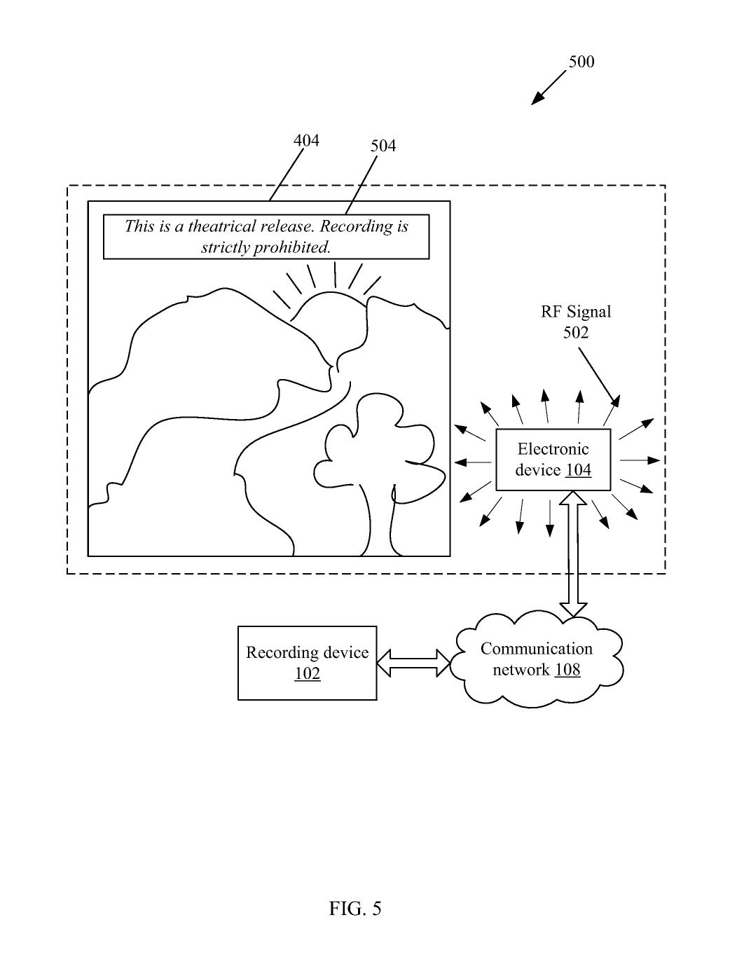

FIG. 5 illustrates a second exemplary scenario 500 to implement the disclosed method and system to disable data recording, in accordance with an embodiment of the disclosure. FIG. 5 is explained in conjunction with elements from FIG. 1, FIG. 2, and FIG. 3. With reference to FIG. 5, there is shown the recording device 102 (as shown in FIG. 1), the electronic device 104 (as shown in FIG. 1), and the data 404 (as shown in FIG. 4). There is further shown a radio frequency (RF) signal 502 that may be similar to the signal 106 (as shown in FIG. 1). There is further shown a watermark 504 indicate that photography of the data 404 is prohibited.

With reference to FIG. 5, as explained in FIG. 4, the data 404 may correspond to the painting displayed in the art exhibition. The electronic device 104 may be placed in vicinity of the data 404. As shown in FIG. 5, the electronic device 104 may be placed in vicinity of the data 404 in such a manner that the RF signal 502 generated by the electronic device 104 encompasses a pre-defined area within the vicinity of the data 404.

In accordance with an embodiment, the recording device 102 may be within the pre-defined proximity range of the electronic device 104. The recording device 102 may be associated with a device identifier, “Id: 101”. The sensing device 306 (as shown in FIG. 3) of the electronic device 104 may detect the recording device 102. In response to the detection, the electronic device 104 may generate and transmit the RF signal 502.

In accordance with an embodiment, the electronic device 104 may be operable to embed an identifier list, such as, “Exception list: 1. Id_005”, within the RF signal 502. The identifier list may include a list of identifiers associated with an authorized recording device with a device identifier, “Id_005”. The RF signal 502 may be immune to be superimposed by a white noise signal. The RF signal 502 may be further immune to be superimposed by another signal. The another signal may be a previously copied signal from one or more electronic circuitries from within the recording device, previously transmitted signal by the recording device, and/or previously recorded signal within the recording device. The strength of the RF signal 502 may exceed the pre-defined threshold value, so that it may be detected by one or more recording devices, such as the recording device 102 and another electronic device (not shown). In accordance with an embodiment, the electronic device 104 may be operable to embed a watermark 504 in the RF signal 502 to indicate that photography of the data 404 is prohibited.

The transceiver 308 (as shown in FIG. 3) may transmit the RF signal 502. The RF signal 502 may be embedded with the watermark 504 and the identifier list. The RF signal 502 may be received by the transceiver 208 (as shown in FIG. 2) of the recording device 102, when within the pre-defined proximity range of the data 404. One or more CMOS sensors in the sensing device 206 (as shown in FIG. 2) may detect the RF signal 502. The processor 202 (as shown in FIG. 2), in conjunction with the sensing device 206, may be operable to detect the watermark 504 in the received RF signal 502. The processor 202 (as shown in FIG. 2), in conjunction with the sensing device 206, may be operable to detect the embedded identifier list, “Exception list: 1. Id_005”, in the received RF signal 502.

The processor 202 may compare the watermark 504 in the received RF signal 502 with a pre-stored list of watermarks retrieved from the memory 204. The processor 202 may further compare the detected identifier list in the received RF signal 502 with an identifier, such as the device identifier, “Id_101”, retrieved from the memory 204. In accordance with an embodiment, the watermark 504 in the received RF signal 502 may match with one of the plurality of watermarks and the detected identifier list in the received RF signal 502 may not match with the device identifier, “Id_101”. In such a case, the processor 202 may be disabled to record the data 404. In accordance with another embodiment, another recording device (not shown) with the device identifier, “Id_101” may desire to capture and record the data 404. The processor (not shown) of the other recording device, in conjunction with associated sensing device (not shown), may detect both the watermark 504 and the identifier list, “Exception list: 1. Id_005”, from the received RF signal 502. In such a case, the watermark 504 in the received RF signal 502 may match with one of the plurality of watermarks. Further, each device identifier from the detected identifier list may match with the device identifier, “Id_005”, of the other recording device. In such a case, the processor in the other recording device may be allowed to record the data 404.

In accordance with another exemplary scenario, the sensing device 306 may be operable to detect the recording device 102, when within a pre-defined proximity range of the electronic device 104. The recording device 102 may be operable to transmit the device identifier, “Id:101”, to the electronic device 104. The device identifier, “Id:101”, may be transmitted to the electronic device 104, via one of a Wi-Fi network, a Bluetooth network, or other such limited range networks. The processor 302 may receive the device identifier, “Id:101”, transmitted by the recording device 102. The authorization unit 312 may compare the received device identifier with a pre-stored identifier list of authorized recording devices. The received device identifier, “Id:101”, may not match with the pre-stored identifier list of authorized recording devices, “Exception list: 1. Id_005”. In such a case, the signal generator 310 may generate the RF signal 502. The processor 302 may be operable to embed the watermark 504 in the RF signal 502. The RF signal 502 may be transmitted by the transceiver 308. The recording device 102 may be operable to detect the RF signal 502 when the strength of the RF signal 502 exceeds a pre-defined threshold value. The RF signal 502 may be immune to be superimposed by the white noise signal and/or another signal, such as a previously copied signal from one or more electronic circuitries from within the recording device 102. The RF signal 502 may be detected by the sensing device 206 of the recording device 102. Based on the watermark 504 in the RF signal 502, the processor 302 may be operable to disable the recording functionality of the recording device 102.

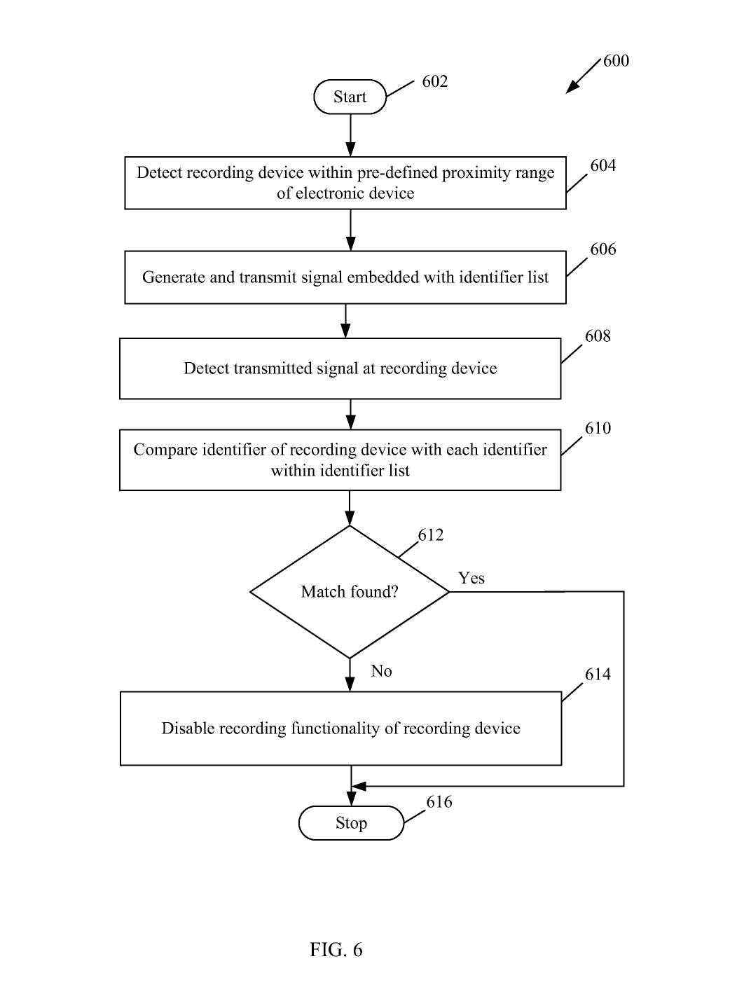

FIG. 6 is a flow chart that illustrates a method 600 to disable data recording, in accordance with an embodiment of the disclosure. FIG. 6 is described in conjunction with elements of FIG. 1, FIG. 2, and FIG. 3. With reference to FIG. 6, the method may be implemented in the electronic device 104 and/or in the recording device 102.

The method 600 begins at step 602 and proceeds to step 604. At step 604, the sensing device 306 of the electronic device 104 may detect that the recording device 102 is within a pre-defined proximity range of the electronic device 104. At step 606, the signal generator 310 may generate the signal 106 embedded with a watermark and an identifier list and transmit the generated signal 106. At step 608, the sensing device 206 may detect the signal 106 embedded with the watermark and the identifier list. At step 610, the processor 202 may compare the identifier of the recording device 102 with the identifier list. The processor 202 may further compare the watermark with the plurality of watermarks stored in the memory 204. At step 612, the processor 202 may determine whether a match is found for the identifier of the recording device 102 or not. When a match is found for the identifier of the recording device 102, the processor 202 may not disable the recording functionality of the recording device 102 and the control passes to end step 616. When a match is not found, control passes to step 614. At step 614, the processor 202 may disable the recording functionality of the recording device 102. Control passes to end step 616.

In accordance with an embodiment of the disclosure, a device to disable data recording may comprise the electronic device 104 (FIG. 1). The electronic device 104 may be communicatively coupled to the communication network 108 (FIG. 1). The electronic device 104 may comprise one or more processors, such as the processor 302 (FIG. 3). The processor 302 may be operable to generate the signal (FIG. 1) when the recording device 102 (FIG. 1) may be within a pre-defined proximity range of the electronic device 104. The processor 302 may be further operable to transmit the generated signal to the recording device 102. In response to the signal 106, the recording device 102 may disable the data recording functionality of the recording device 102.

In exemplary embodiments of the disclosure, a system to disable data recording may comprise the recording device 102 (FIG. 1). The recording device 102 may be communicatively coupled to the communication network 108 (FIG. 1). The recording device 102 may comprise one or more processors, such as the processor 202 (FIG. 2). The processor 202 may be operable to detect the signal 106 (FIG. 1) generated by the electronic device 104 (FIG. 1) when the recording device 102 may be within a pre-defined proximity range of the electronic device 104. The processor 202 may be further operable to disable the data recording when the signal 106 may be detected.

Various embodiments of the disclosure may provide a non-transitory computer readable medium and/or storage medium, and/or a non-transitory machine readable medium and/or storage medium having stored thereon, a machine code and/or a computer program having at least one code section executable by a machine and/or a computer to disable data recording. The at least one code section in an electronic device 104 may cause the machine and/or computer to perform the steps, which may comprise detection of the recording device 102 generated by the electronic device 104 when the recording device 102 may be within a pre-defined proximity range of the electronic device 104. The data recording may be disabled when the signal 106 is detected.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

1. A method for disabling recording of data, said method comprising:
in a recording device:
detecting a signal generated by an electronic device in a case said recording device is within a pre-defined proximity range of said electronic device; and
disabling said recording of said data based on said detected signal,
wherein said detected signal is embedded with an identifier list which corresponds to one or more authorized recording devices.

2. The method according to claim 1, wherein said recording is disabled in a case an identifier associated with said recording device does not match said identifier list.

3. (canceled)

4. The method according to claim 1, wherein said detected signal comprises an embedded watermark, wherein said disabling of said data recording is based on said embedded watermark.

5. The method according to claim 1, wherein said signal is transmitted by said electronic device via one of a radio frequency (RF) spectrum, a wireless fidelity (Wi-Fi) network, and a Bluetooth network.

6. The method according to claim 1, wherein said signal is immune to be superimposed by a white noise signal.

7. The method according to claim 1, wherein said signal is immune to be superimposed by another signal, wherein said another signal is previously copied from one or more electronic circuitries from within said recording device, previously transmitted by said recording device, and/or previously recorded within said recording device.

8. The method according to claim 1, wherein said recording device is disabled in a case a white noise signal is detected.

9. The method according to claim 1, further comprising comparing strength of said detected signal with a pre-defined threshold value.

10. The method according to claim 9, wherein said recording is disabled in a case said strength of said detected signal exceeds said pre-defined threshold value.

11. A method for disabling recording of data, said method comprising:
in an electronic device:
transmitting a signal to a recording device in a case said recording device is within a pre-defined proximity range of said electronic device,
wherein a recording of said data by said recording device is disabled in response to said transmitted signal,
wherein said transmitted signal is embedded with an identifier list which corresponds to one or more authorized recording devices.

12. The method according to claim 11, further comprising generating said signal in a case said recording device is within a pre-defined proximity range of said electronic device.

13. The method according to claim 11, further comprising embedding a watermark within said transmitted signal.

14. The method according to claim 11, further comprising comparing an identifier associated with said recording device with said embedded identifier list.

15. The method according to claim 14, further comprising authorizing said recording device to record said data based on said comparison.

16. The method according to claim 11, wherein said signal is immune to be superimposed by a white noise signal and/or another signal, wherein said another signal is previously copied from one or more electronic circuitries from within said recording device, previously transmitted by said recording device, and/or previously recorded within said recording device.

17. A system for disabling recording of data, said system comprising:
one or more circuits in a recording device, said one or more circuits being operable to:
detect a signal generated by an electronic device in a case said recording device is within a pre-defined proximity range of said electronic device; and
disable said recording of said data based on said detected signal,
wherein said detected signal is embedded with an identifier list which corresponds to one or more authorized recording devices.

18. The system according to claim 17, wherein said detected signal comprises an embedded watermark.

19. The system according to claim 17, wherein said one or more circuits are operable to compare an identifier associated with said recording device with said identifier list embedded within said detected signal.

20. The system according to claim 19, wherein said one or more circuits are operable to authorize said recording device to record said data based on said comparison.

21. A system for disabling recording of data, said system comprising:
one or more circuits in an electronic device, said one or more circuits being operable to:
transmit a signal to a recording device in a case said recording device is within a pre-defined proximity range of said electronic device,
wherein a recording of said data by said recording device is disabled in response to said transmitted signal,
wherein said transmitted signal is embedded with an identifier list which corresponds to one or more authorized recording devices.

22. The system according to claim 21, wherein said one or more circuits are operable to embed a watermark within said transmitted signal.

23. The system according to claim 21, wherein said one or more circuits are operable to compare an identifier associated with said recording device with said embedded identifier list.

24. The system according to claim 23, wherein said one or more circuits are operable to authorize said recording device to record said data based on said comparison.
